(19) United States
(12) Patent Application Publication
(10) Pub. No.: US 2003/0169819 A1
(43) Pub. Date: Sep. 11, 2003

(54) Video-signal decoder and method for removing interferences in a video image

(76) Inventors: Robert Kutka, Geltendorf (DE); Jurgen Pandel, Feldkirchen-Westerham (DE)

Correspondence Address: Patrick J O'Shea, Samuels Gauthier & Stevens, Suite 3300, 225 Franklin Street, Boston, MA, 02110, US

(21) Appl. No.: 10/275,744

(22) PCT Filed: May 5, 2001
(86) PCT No.: PCT/EP01/05119

(30) Foreign Application Priority Data
May 8, 2000 (DE) 100 22 264.1

(51) Int. Cl. H04N 11/02; H04N 7/12

(52) U.S. Cl. 375/240.25; 375/240.21

(57) ABSTRACT

The invention relates to a video signal decoder for generating a video image that consists of cumulative image data blocks, of a differential image comprising differential image data blocks and motion vectors, and of a down-sampling device (28) that down-samples the cumulative image data blocks for producing reduced reference image data blocks. The video signal decoder further comprises a reference image data memory (30) for intermediate storage of the reduced reference data blocks, an up-sampling devices that up-samples the reduced reference image data blocks that are read out from the reference image data memory and that are motion-compensated by means of the motion vectors, thereby producing reference image data blocks. A reconstruction filter (36) filters the reference image data blocks produced by up-sampling and produces predecessor image data blocks, said reference image data blocks being filtered by interpolation within the data block limits. A summation circuit (12) produces a sum of the produced predecessor image data blocks and the differential image data blocks to produce the cumulative image data blocks.

The invention relates to a video signal decoder for generating an interference-free video image, and to a method for removing image interference, especially image blurring and bar artifacts.

Digital video signal decoders, especially those for television sets, are able to receive not only CCIR and PAL image formats but also high-resolution video signals and reproduce them in reduced image size on conventional display screens. HDTV television sets (HDTV: High Definition Television) reproduce television images in a 16:9 image format, which is best, suited to the range of human vision. HDTV televisions sets display television images with 1125 or 1250 lines, these images being considerably sharper than conventional television images with only 625 image lines. Conventional television sets using PAL systems have a 4:3 image format, which may be converted to the 16:9 image format of an HDTV television set. The Japanese counterpart to HDTV is the MOSE television system (MOSE: Multiple Sub-Nyquist Encoding).

Under current video coding standards such as H26 or MPEG, video images are constructed using motion-compensated prediction. The video signal coder in the transmitter stores the predecessor image or reference image in a reference image memory. The current successor image and predecessor image are compared in the transmitter by a motion detector which generates coded motion information in the form of motion vectors. The differential image between the predecessor image and the current successor image, as well as the motion vectors, are sent to the HDTV receiver. Based on the received differential image and the received motion vectors, the receiver is able to make a forecast or prediction about the successor image. To achieve this, image data blocks consisting, for example, of 16×16 pixels, may be shifted from the predecessor image to ensure the most accurate possible prediction of the successor image. To make this prediction, conventional video signal decoders are provided with a reference image memory which has an HDTV image format.

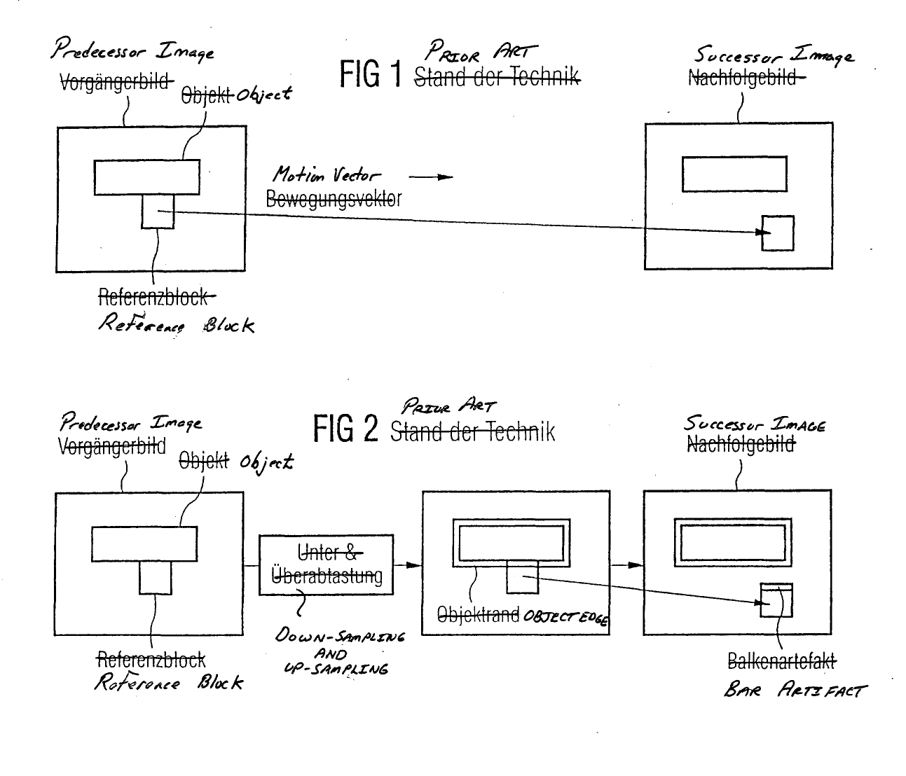

FIG. 1 shows in schematic form the prediction or calculation of a successor image from a predecessor image in which an object to be displayed lies directly next to a reference block which is shifted by the transmitted motion vector. There are no so-called bar artifacts generated here. However, these conventional HDTV video signal decoders have the disadvantage that the necessary reference image memory requires an extremely large memory capacity due to the high-resolution HDTV image format and is, as a result, relatively expensive.

To save memory capacity in the reference image memory within the video signal decoder, increasing use is therefore being made of smaller reference image memories with smaller memory capacities. This approach is achieved by down-sampling the television image and by compression techniques. Prior-art video signal decoders of this type which employ reference image memories of reduced capacity have, however, the serious disadvantage that image blurring and image bar artifacts may be produced due to the required down-sampling and up-sampling processes.

FIG. 2 shows schematically how an image bar artifact is produced in a conventional video signal decoder of this type. To obtain the motion-compensated prediction, the images to be written to the reference image data memory are first down-sampled so that only each n^{th} pixel in every line and each m^{th} column is stored, thereby yielding a compression factor of n×m. The compressed image data are temporarily stored in the small or reduced reference image data memory, and then expanded to their original data size (up-sampling) after being read out from the reference image memory. The missing image data or pixels are interpolated via an up-sampling filter from the adjacent pixels. Whenever an object happens to be located exactly on the edge of a reference block, image bar artifacts may occur, as seen in FIG. 2. Due to the down-sampling and up-sampling, a blurred expanded edge of the object is produced which is located in the immediately adjacent reference block or which extends into this block. If this reference block is now shifted by prediction to form the successor image based on the motion vectors transmitted, an image bar artifact is produced. The image bar artifact is the blurred object edge expanded or shifted within the reference block. The thereby-shifted object edges are spurious bar structures which cannot be corrected in conventional video signal decoders. Since the object edges are essentially caused by low-pass filtering of the reference image, the remedy heretofore has been to prevent the bar artifacts by weakening the low-pass filtering. Weakening low-pass filtering, however, has the effect of reducing the smoothing of the image signal—with the result that aliasing artifacts in the form of stair-steps, flickering, or moiré patterns are created.

The goal of the invention is therefore to provide a video signal decoder which includes a reference image data memory and a method for removing image interference wherein the reference image data memory provided has a smaller memory size than the image format to be displayed, and wherein no image interference occurs.

This goal is achieved according to the invention by a video signal decoder having the characteristic features indicated in Claim 1 and by a method having the characteristic features indicated in Claim 18.

The invention creates a video signal decoder to generate a video image which consists of cumulative image data blocks from a differential image which in turn has differential image data blocks and motion vectors including:

a down-sampling device which down-samples the cumulative image data blocks to form reduced reference image data blocks,

a reference image data memory to temporarily store the reduced reference image data blocks,

an up-sampling device which up-samples the reduced reference image data blocks read out from the reference image data memory and motion-compensated by the motion vectors to form reference image data blocks,

a reconstruction filter which filters the reference image data blocks formed by up-sampling to generate predecessor image data blocks, the reference image data blocks being filtered by interpolation within the data block limits, and

a summation circuit to sum the generated predecessor image data blocks and differential image data blocks to generate cumulative image data blocks.

The video signal decoder preferably has a video signal processing circuit for the signal processing of a received video signal to form a differential image.

This video signal processing circuit preferably has a decoding device to decode transmitted coded video data words of variable word length.

In addition, the video signal processing circuit preferably has an inverse signal quantification device to spread the signal amplitude.

In addition, the video signal processing circuit preferably has an inverse transformation device.

The inverse transformation device preferably performs an IDCT transformation.

In another preferred embodiment, a first low-pass filter to filter the block edges is connected following the summation circuit.

This first low-pass filter is preferably an FIR low-pass filter.

The FIR low-pass filter here is preferably a third-order FIR filter.

A second low-pass filter to smooth the cumulative image data blocks is preferably connected in front of the down-sampling device.

This second low-pass filter is also preferably an FIR low-pass filter.

The image data blocks preferably consist of 16×16 image pixels.

The reduced reference image data blocks temporarily stored in the reference image data memory preferably have 8×8 image pixels.

In an especially preferred embodiment, the down-sampling device down-samples each supplied cumulative image data block using an adjustable compression factor

This compression factor is preferably four.

The video signal decoder according to the invention is employed preferably for decoding the video signal in an HDTV television set.

In addition, the video signal decoder according to the invention is employed in mobile telephones which have a display screen.

In addition, the invention creates a method for removing video interference in a video image consisting of cumulative image data blocks, wherein the method has the following steps, specifically:

converting a received differential video signal to a differential image which contains differential image data blocks and motion vectors,

down-sampling the cumulative image data blocks to generate reduced reference image data blocks,

storing the reduced reference image data blocks,

block-by-block reading out the reduced reference image data blocks,

performing a motion compensation on the read-out reduced reference image data blocks as a function of the motion vectors,

up-sampling the motion-compensated, reduced reference image data blocks to generate reference image data blocks,

filtering the generated reference image data blocks by interpolation within the block limits of the reference image data blocks to generate the predecessor image data blocks,

summing the predecessor image data blocks and the differential image data blocks to form cumulative image data blocks which form the video image.

The following discussion describes preferred embodiments of the video signal decoder according to the invention and of the method according to the invention for removing image interference in a video image with reference to the attached figures to explain features fundamental to the invention.

FIG. 1 shows the generation of a successor image from a predecessor image by prediction in a conventional video signal decoder without reduced reference image data memory.

FIG. 2 shows the generation of a successor image from a predecessor image by prediction in a conventional video signal decoder with reduced reference image data memory in order to illustrate the fundamental problem addressed by the invention.

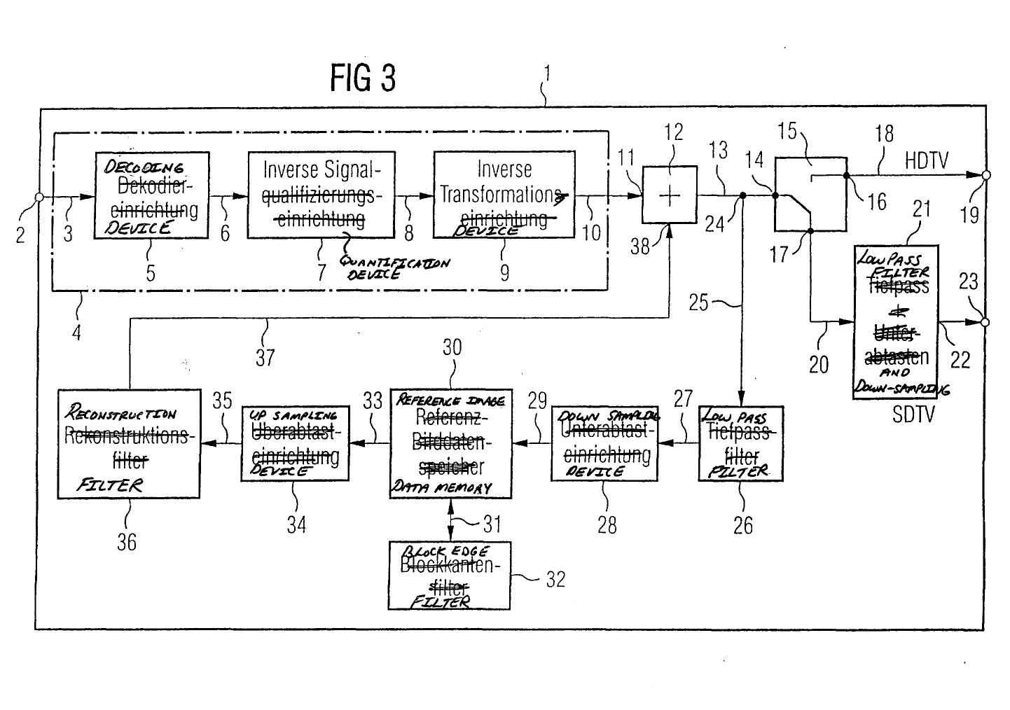

FIG. 3 shows a preferred embodiment of the video signal decoder according to the invention.

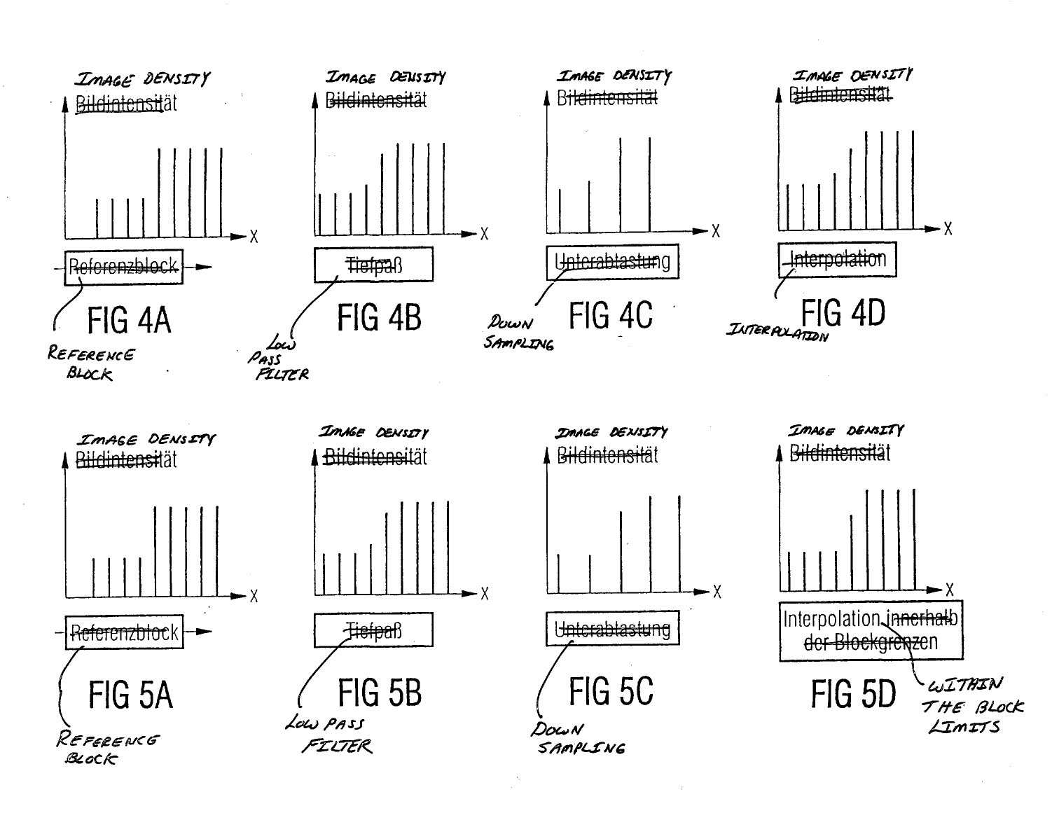

FIGS. 4a through 4d show the creation of one type of image interference in a reference data block during down-sampling when the pixel to be stored is located at the edge of the reference block.

FIGS. 5a through 5d show a case in which the pixels to be stored are not located at the edge of the reference block.

FIG. 3 shows a block diagram of a preferred embodiment of the video signal decoder 1.

Video signal decoder 1 has a signal input 2 through which it receives a video signal. The video signal passes through signal line 3 to a three-stage video signal processing circuit 4. Video signal processing circuit 4 has at its input a decoding device 5 to decode the received coded video data words of variable data word length. At its output, decoding device 5 is connected through line 6 with an inverse signal quantification device 7 which implements signal amplitude spreading of the video signal. The video signal of spread signal amplitude passes through a signal line 8 to an inverse transformation device 9 which performs a decorrelation. Inverse transformation device 9 is preferably an IDCT transformation device. Inverse transformation device 9 delivers the transformed video signal through a signal line 10 to a first input 11 of a summation circuit 12. Summation circuit 12 is connected through a line 13 to an input 14 of a controlled switching device 15. Controlled switching device 15 has two signal outputs 16, 17. First output 16 of controllable switching device 15 connects through line 18 to a signal output 19 of video signal decoder 1 according to the invention. The function of signal output 19 is to supply a high-resolution HDTV television signal. Second signal output 17 of controllable switching device 15 is connected through a signal line 20 to a device 21 for the purpose of low-pass filtering and down-sampling. This device supplies a standard SDTV television signal through a line 22 and a second signal output 23 of video signal decoder 1 according to the invention.

A first low-pass filter (not shown) to filter the block edges of the cumulative image data blocks is preferably connected following summation circuit 12. This low-pass filter is preferably a third-order FIR low-pass filter. At a signal branch node 24, the image data are fed through a line 25 to another low-pass filter 26 which smoothes the cumulative image data blocks. This smoothing prevents aliasing artifacts in the form of stair-steps, flickering, or moiré patterns. Low-pass filter 26 is preferably a third-order FIR low-pass filter. Filtering by low-pass filter 26 occurs horizontally and vertically.

The filter coefficients for pixels not located on the block edges are:

c1=¼

c2=½

c3=¼

If p1 represents an image pixel to be filtered, and p0 and p2 are its adjacent neighboring pixels, then image pixel p1 is replaced by

p1=c1*p0+½*p1+¼*p2,

and thus using the above filter coefficients, the following equation applies:

p1=¼*p0+½*p1+¼*p2 (1)

For image pixels which are located on the block edge, the filter coefficients are adjusted as follows:

c1=½

c2=½

If p1 represents an edge pixel and p2 a neighboring pixel inside the block, the edge pixel is replaced by:

p1=c1*p1+c2*p2

so that, using the above coefficients, the following equation applies:

p1=½*p1+½*p2 (2)

The output of low-pass filter 26 is connected through a line 27 to a down-sampling device 28. Down-sampling device 28 performs a down-sampling of the supplied cumulative image data blocks to form reduced reference image data blocks. The down-sampling device samples each supplied cumulative image data block using an adjustable compression factor. The supplied image data blocks preferably have 16×16 image pixels. Down-sampling with a compression factor of four forms reduced reference image data blocks consisting of 8×8 image pixels as a result of the down-sampling. The reduced reference image data blocks are written through line 29 to a reference image data memory 30 and temporarily stored there. Reference image data memory 30 has a reduced memory size compared to the HDTV format. Reference image data memory 30 is connected through lines 31 to an obligatory block edge filter 32 by which filtering is performed in the transverse direction relative to the data block edges. Block edge filter 32 is preferably an FIR filter having the following filter coefficients:

c1=¼

c2=½

c3=¼

If p1 represents an edge pixel, and p0 and p2 are neighboring pixels, then the edge pixel p1 is replaced by:

p1=¼*p0+½*p1+¼*p2

Using the preferred filter coefficients listed above yields the following:

p1=¼*p0+½*p1+¼*p2 (3)

The thus-filtered reduced reference image data blocks are written back to reference image data memory 30 and pass through line 33 to an up-sampling device 34. The reference image data blocks read from reference image data memory 30 are motion-compensated as a function of the motion vectors and then up-sampled by up-sampling device 34, that is, expanded to their original size. The reference image data blocks generated by up-sampling are fed through a line 35 to a reconstruction filter 36. Reconstruction filter 36 filters the supplied reference image data blocks to generate predecessor image data blocks, the reference image data blocks being filtered by interpolation within the data block limits. The result is that the effect of image interference, especially bar artifacts, is precluded from adjacent blocks.

Reconstruction filter 36 filters for the up-sampling case in which the reference image data blocks have a factor of two both horizontally and vertically. Non-stored image pixels are initially set to zero.

The filter coefficients of reconstruction filter 36 which are not located on the block edges are:

c1=½

c2=1

c3=½

The filter coefficients of reconstruction filter 36 for edge pixels are:

c1=1

c2=1

When p1 represents an edge pixel and p2 a neighboring pixel within the block, the edge pixel is replaced by:

p1=c1*p1+c2*p2

Using the coefficients listed above yields the following:

p1=p1+p2 (4)

Filtering the reference image data blocks by reconstruction filter 36 generates the predecessor image data blocks which are fed through line 37 [and]¹ a second input 38 to summation circuit 12. Summation circuit 12 sums the generated predecessor image data blocks and the reference image data blocks applied to first input 11 to form cumulative image data blocks. ¹Word added by translator.

FIGS. 4 and 5 show different cases for the block edges. In the case constellation shown in FIG. 4, the pixel to be stored is located on the edge of the reference image data block.

As is evident in FIG. 4a, a display object of higher image intensity is located directly adjacent to a reference block. The image intensity distribution shown in FIG. 4B is produced by low-pass filtering. Subsequently, down-sampling is performed by down-sampling device 28, thereby generating the image intensity distribution shown in FIG. 4C. Finally, as a result of up-sampling by up-sampling device 34 and subsequent interpolation in reconstruction filter 36, the image intensity distribution shown in FIG. 4D is generated. It is evident here that the image interference, i.e. the blurred object edge, migrates into the interior of the reference block as a result of down-sampling and cannot now be prevented by subsequent up-sampling.

FIG. 5B shows a case constellation in which the pixel to be stored is not located on the edge of the reference block. By limiting the up-sampling to the block interior, the effect of spurious image structures, especially bar artifacts, on the adjacent data block is precluded. The reference block has a uniformly low image intensity, as is evident in FIG. 5D. The adjacent image object with its higher image intensity has therefore not produced any bar artifact in the reference block.

The case constellations shown in FIGS. 4 and 5 are statistically equally probable, so that viewed statistically half of all possible bar artifacts are removed.

The bar artifacts produced by the case constellation shown in FIG. 4 at the edge of the reference block can be filtered out by targeted filtering of the block edges in the current image after motion compensation by reconstruction filter 36. In FIG. 4D, the spurious image artifact is evident on the edge of the reference block due to an image pixel which has an increased image intensity by comparison with the remaining image pixels of the reference block. Reconstruction filter 36 acts at the block edge and filters out the bar artifact. This minimal filtering results in only a small fraction of the real image structure being modified, while the bar artifacts are nevertheless almost completely suppressed.

The filtering by reconstruction filter 36 preferably takes place only when the motion vectors of the blocks adjoining the block edge are different since this is the only case in which there is a risk that blurred optical edges will be moved away from the objects.

The video signal decoder according to the invention shown in FIG. 3 for generating a video image has a plurality of applications. Video signal decoder 1 according to the invention may be employed to improve the picture quality of digital TV decoders receiving HDTV video signals. In addition, it is also usable for format conversion in video cell phones and “Personal Agents”². In these mini-displays, the video signal decoder according to the invention enables television signals to be decoded and displayed where only a reduced memory capacity is available. ²Translator's note: It is possible that the writer intended to use “Personal Digital Assistants” (“PDAs”) here.

FIG. 1 Prior Art

| | |
|---|---|
| Vorgängerbild | predecessor image |
| Objekt | object |
| Referenzblock | reference block |
| Bewegungsvektor | motion vector |
| Nachfolgebild | successor image |

FIG. 2 Prior Art

| | |
|---|---|
| Vorgängerbild | predecessor image |
| Objekt | object |
| Referenzblock | reference block |
| Unter & | down-sampling and |
| Überabtastung | up-sampling |
| Objektrand | object edge |
| Nachfolgebild | successor image |
| Balkenartefakt | bar artifact |

FIG. 3

| | |
|---|---|
| 5 | decoding device |
| 7 | inverse signal quantification device |
| 9 | inverse transformation device |
| 21 | low-pass filter and down-sampling |
| 26 | low-pass filter |
| 28 | down-sampling device |
| 30 | reference image data memory |
| 32 | block edge filter |
| 34 | up-sampling device |
| 36 | reconstruction filter |

FIGS. 4A-4D

| | |
|---|---|
| Bildintensität | image intensity |
| Referenzblock | reference block |
| Tiefpass | low-pass filter |
| Unterabtastung | down-sampling |
| Interpolation | interpolation |

FIGS. 5A-5D [same as above]

5D Interpolation innerhalb der Blockgrenzen interpolation within the block limits

1. Video signal decoder for generating a video image, which consists of cumulative image data blocks, from a differential image which has differential image data blocks and motion vectors including:
a down-sampling device (28) which down-samples the cumulative image data blocks to form reduced reference image data blocks;
a reference image data memory (30) to temporarily store the reduced reference image data blocks;
an up-sampling device which up-samples the reduced reference image data blocks read out from the reference image data memory and motion-compensated by the motion vectors to form reference image data blocks;
a reconstruction filter (36) which filters the reference image data blocks formed by up-sampling to generate predecessor image data blocks, the reference image data blocks being filtered by interpolation within the data block limits; and
a summation circuit (12) to sum the generated predecessor image data blocks and differential image data blocks to generate cumulative image data blocks.

2. Video signal decoder according to claim 1,
characterized in
that a video signal processing circuit (4) is provided for the signal processing of a transmitted video signal to form the differential image.

3. Video signal decoder according to claim 2,
characterized in
that the video signal processing circuit (4) has a decoding device (5) to decode transmitted coded video data words of variable data word length.

4. Video signal decoder according to claim 2,
characterized in
that the video signal processing circuit (4) has an inverse signal quantification device for the purpose of signal amplitude spreading.

5. Video signal decoder according to claim 2,
characterized in
that the video signal processing circuit (4) has an inverse transformation device.

6. Video signal decoder according to claim 5,
characterized in
that the inverse transformation device performs an IDCT transformation.

7. Video signal decoder according to one of the foregoing claims,
characterized in
that a first low-pass filter to filter the block edges of the cumulative image data blocks is connected following the summation circuit (12).

8. Video signal decoder according to claim 7,
characterized in
that the first low-pass filter is an FIR low-pass filter.

9. Video signal decoder according to claim 8,
characterized in
that the FIR low-pass filter is a third-order FIR low-pass filter.

10. Video signal decoder according to one of the foregoing claims,
characterized in
that a second low-pass filter (26) to smooth the cumulative image data blocks is connected in front of the down-sampling device (28).

11. Video signal decoder according to one of the foregoing claims,
characterized in
that the second low-pass filter (26) is an FIR low-pass filter.

12. Video signal decoder according to one of the foregoing claims,
characterized in
that the image data blocks consist of 16×16 image pixels.

13. Video signal decoder according to one of the foregoing claims,
characterized in
that the reduced reference image data blocks temporarily stored in the reference image data memory (30) consist of 8×8 image pixels.

14. Video signal decoder according to one of the foregoing claims,
characterized in
that the down-sampling device (28) down-samples each supplied cumulative image data block by an adjustable compression factor.

15. Video signal decoder according to claim 14,
characterized in
that the compression factor is four.

16. HDTV television set which contains the video signal decoder according to claim 1.

17. Mobile telephone which contains the video signal decoder according to claim 1.

18. Method of removing image interference in a video image which consists of cumulative image data blocks, including the steps:
(a) converting a received differential video signal to a differential image which contains differential image data blocks and motion vectors;
(b) down-sampling the cumulative image data blocks to generate reduced reference image data blocks;
(c) storing the reduced reference image data blocks;
(d) block-by-block reading of the reduced reference image data blocks;
(e) performing a motion compensation on the read-out reduced reference image data blocks as a function of the motion vectors;
(f) up-sampling the motion-compensated, reduced reference image data blocks to generate reference image data blocks;
(g) filtering the generated reference image data blocks by interpolation within the block limits of the reference image data blocks to generate the predecessor image data blocks;
(h) summing the predecessor image data blocks and the differential image data blocks to form cumulative image data blocks which form the video image.
